(19) United States
(12) Patent Application Publication
(10) Pub. No.: US 2009/0141053 A1
(43) Pub. Date: Jun. 4, 2009

(54) Printing methods and apparatus

(75) Inventor: Max W. Dahlgren, Dallas, TX (US)

Correspondence Address: BUCHANAN, INGERSOLL & ROONEY PC, POST OFFICE BOX 1404, ALEXANDRIA, VA, 22313-1404, US

(73) Assignee: EPIC PRODUCT INTERNATIONAL CORP., Arlington, TX (US)

(21) Appl. No.: 12/292,168

(22) Filed: Nov. 13, 2008

Related U.S. Application Data
(60) Provisional application No. 60/996,349, filed on Nov. 13, 2007.

(51) Int. Cl. H04N 1/034; B41J 2/01

(52) U.S. Cl. 347/3; 347/104

(57) ABSTRACT

The identical printing of a stack of sheets (e.g., paper) is performed by vertically stacked inkjet printing units, each of which prints sheets at a printing speed. All sheets are fed from a stack along an infeed path at a feeding speed which is faster than the printing speed. The sheets are sequentially introduced into the respective printing heads, e.g., by the actuation of a gate mechanism disposed in the infeed path. After the sheets have been printed in the printing units at the slower printing speed, and after the print medium has been fixed, the sheets are discharged from the printing units and fed along a common outfeed path at the higher feeding speed. For variable-data printing, raster image processing is performed by assigned separate RIP computer units to process respective batches of the pages of the printing job.

This application claims the benefit of the Nov. 13, 2007 filing date of Provisional Application No. 60/996,349.

### BACKGROUND OF THE INVENTION

The invention relates to a printing apparatus and method.

Inkjet printing is highly favored due to its ability to produce high-quality printing. However, the quality diminishes as printing speed increases (i.e., the speed of the sheets past the printing head), so high-quality printing on commercially affordable printers can be achieved only at production rates that are less than optimum.

It would thus be desirable to provide a printing method and apparatus, preferably but not necessarily employing inkjet printing, which attains higher production rates without sacrificing quality.

Another shortcoming in the printing field involves large variable-data print jobs, i.e., where a large number of sheets are to be printed with different images on most or all sheets. Current digital printing systems for performing such variable-data printing jobs typically employ a raster image processor (RIP) which determines what images is to be printed on each sheet, as well as at the proper location and color of the images. The RIP converts vector digital information, such as a PostScript file for example, into a high-resolution raster image readable by the printer. Typically, when the RIP for all pages is completed, printing begins. For a large print job, it generally takes considerable time for the RIP to be performed, thus seriously delaying the printing operation which itself might require only a fraction of the time required for the RIP. This has adverse impact on a company's ability to earn profit and maximize shop throughput.

Printing apparatuses are known which employ a so-called “quick-start” feature in which the printing commences after the RIP of a certain number of the pages has been completed. However, since the printing of a page is typically performed more quickly than the RIP, the printing will “catch up” to the RIP, thereby delaying the final printing until the RIP has been finished. In other words, the printing phase may start sooner due to the “quick-start” feature, but it will not end sooner. Moreover, as a result of the “quick-start” feature, the printer will be “tied-up” for the entire RIP phase rather than being available to perform other unrelated printing jobs during the RIP.

Therefore, it would be desirable to maximize the throughput of variable-data printing jobs.

### SUMMARY OF THE INVENTION

In one invention disclosed herein, the printing of images on a stack of printable sheets, such as paper sheets, is performed using a plurality of printing units, such as inkjet printers, each of which prints sheets at a printing speed, preferably selected for achieving high quality. All sheets are fed from a stack along an infeed path at a feeding speed which equals or approximately equals the printing speed multiplied by the number of inkjet printing units in operation. The sheets are introduced alternatingly into the respective printing units, e.g., by the actuation of a gate disposed in the infeed path. After the sheets have been printed in the printing units at the slower printing speed, and the print medium fixed, the sheets are discharged from the printing units and preferably fed along a common outfeed path at the higher feed speed, preferably to a common stacker pile.

Another invention disclosed herein pertains to variable-data printing in which different images are to be printed on a set of pages. A plurality of computing units are provided, each of which performs a RIP operation on a respective quantity of the page set, and then sends signals to a printing apparatus. Thus, no computing unit performs the RIP of all pages of the set; rather each computing unit performs a RIP on only some of the pages.

### BRIEF DESCRIPTION OF THE DRAWINGS

FIG. 1 is a schematic side elevational view of an inkjet printing apparatus according to one invention.

FIG. 2 is a view similar to FIG. 1 showing a modified conveying path through the printing units.

FIG. 3 is a schematic view of a variable-data printing system according to another invention.

### DETAILED DESCRIPTION OF PREFERRED EMBODIMENTS

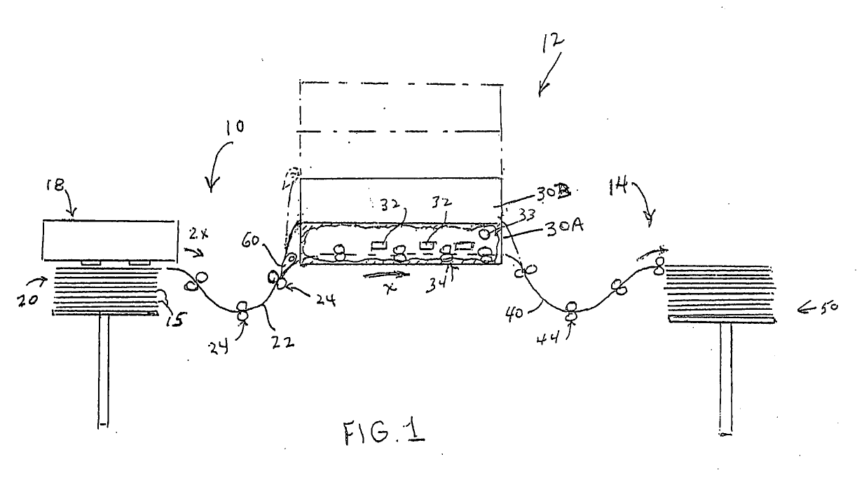

Depicted in FIG. 1 is a printing apparatus comprising a sheet infeed section 10, a printing section 12, and a sheet outfeed section 14. The sheet infeed section 12 comprises a feed mechanism 18 which can be any suitable conventional high-speed sheet feeder capable of feeding printable sheets 15, such as blank paper sheets, sequentially from a preferably vertical stack 20 of sheets (e.g., see U.S. Pat. No. 6,095,513, disclosing a high-speed sheet feeder). The sheets are fed onto an infeed path 22 at a feed speed and are advanced along that path by a conventional advancing mechanism such as roller pairs 24 in which one roller of each pair is driven by a motor. One or more stacks could feed into the feed path.

The printing section 12 comprises a plurality of printing units. Any type of printing units can be used and they can be disposed in any suitable arrangement. However, it is preferable to use vertically-stacked, digital, inkjet printing units, which are desirably of identical construction, wherein two such units 30A, 30B are depicted in solid lines in FIG. 1. (Hereafter the description will refer only to a vertical stack of inkjet printing units.) Each unit 30A, 30B includes a conventional inkjet printing head 32 (or multiple heads in the case of a color printer) and a conventional sheet conveying mechanism such as roller pairs 34 wherein one of the rollers of each pair is driven by a motor to propel the sheets at a predetermined speed as will be discussed.

Also disposed in each printer is a device 33 for “fixing” the print medium, i.e., drying or curing, depending on the nature of the print medium. By “fixing” is meant bringing the print medium to a state where it will not easily rub off or adhere to other sheets, e.g., during normal handling or stacking. That is critical since, according to the present invention, print production throughout is to be considerably increased, resulting in the need to handle large numbers of sheets quickly once leaving the printer. That means that the printed images (i.e., all marks, words, pictures, etc.) must not be capable of rubbing off or sticking to other sheets. The fixing device 33 could be a heater or an UV light-emitting (curing) device, or a device for blowing warm dry air onto the sheets, for example, and should be performed before the sheets exit the printer.

The outfeed section 14 includes an outfeed path 40 to which all of the sheets from the printing units 30A, 30B are fed and advanced by a conventional advancing mechanism, preferably to a common stack pile 50. The advancing mechanism can comprise roller pairs 44 similar to the roller pairs 24 and driven by the same or different motor.

Disposed in the infeed path at the inlet of at least the lower printing unit 30A is a conventional gate 60 (see U.S. Pat. No. 5,382,012, disclosing a gate) which can be pivoted by a driver (e.g., an electric solenoid) between either a first position admitting the next advancing sheet into the printing unit 30A, or a second position preventing such admittance, whereupon the sheet travels to the next printing unit 30B and is guided into that unit. In this way, the fed sheets can be admitted alternately into the first and second printing units 30A, 30B. The respective speeds of the roller pairs 24, 34 and 44 are controlled by a controller, which also controls pivoting of the gate.

As will be explained, this apparatus is capable of increasing the overall printing production rate (i.e., total number of printed sheets per minute) without increasing the printing speed (i.e., the speed of each sheet past the inkjet printing head(s)). That is accomplished in the following manner. A printing speed x is selected which provides an acceptable printing quality, e.g., approximately 60 ft/min. Then, the selected printing speed is multiplied by the number of printing units to be employed in the printing operation, which in this case is two, so 60×2=approximately 120 ft/min which is the feed speed 2X, i.e., the speed at which the sheets are: (1) fed from the stack, (2) advanced along the infeed path, and (3) advanced along the outfeed path. The operation of the gate 60 is set so that immediately successive sheets are fed alternatingly to the two printing units. By employing a feed speed (approximately 120 ft/in.) that approximately equals the selected printing speed (approximately 60 ft/min) times the number of printing units, the sheets will be fed at a rate which produces an overall printing production rate of approximately 120 ft/min, even though the sheets are being printed at the high-quality rate of approximately 60 ft/min. Thus, the apparatus produces high quality printing at a high production rate.

Feeding speed need not precisely equal the printing speed times the number of printing units; rather it could be a bit slower or a bit faster. For example, one might want to feed at a speed a bit faster, in feet per minute than that formula would yield so as to create more distance between the tail edge of a sheet and the lead edge of a following sheet so as to provide ample space and time between sheets to throw a gate or switch in the print feed path.

It will be understood that the printing units could print the same, or different, images on the sheets. Digital inkjet printers allow the nature of the images to vary, so it is possible that variances in the images might result in concurrent variances in the printing speed. The controller will make the necessary variances in the feeding speed to accommodate the varying printing speed. Nevertheless, the feeding speed will be a multiple of the printing speed.

It will be appreciated that modifications of the invention are possible. The sheet feeding mechanism 18 could be of the type which removes sheets from the bottom of the stack instead of from the top of the stack. Moreover, the stack need not be vertical.

Any number of the vertically stacked inkjet printing units can be selected. Thus, if ten units are provided, and the print speed is 60 ft/min, then the feed speed should be approximately 600 ft/min. In that case, the bottom nine printing units would have gates 60.

Also, by employing more than two printing units, it is possible to perform repair or maintenance on one of the printing units while the others operate. To facilitate such repair/maintenance, the vertically stacked printing units can be mounted in a common housing or framework capable of being slid out in a horizontal direction transversely to the direction of paper travel, to provide access to a selected printing unit.

Instead of employing a separate gate for each printing head, a single gate could be provided which directs sheets sequentially to branch paths extending to the inlets of respective printing units.

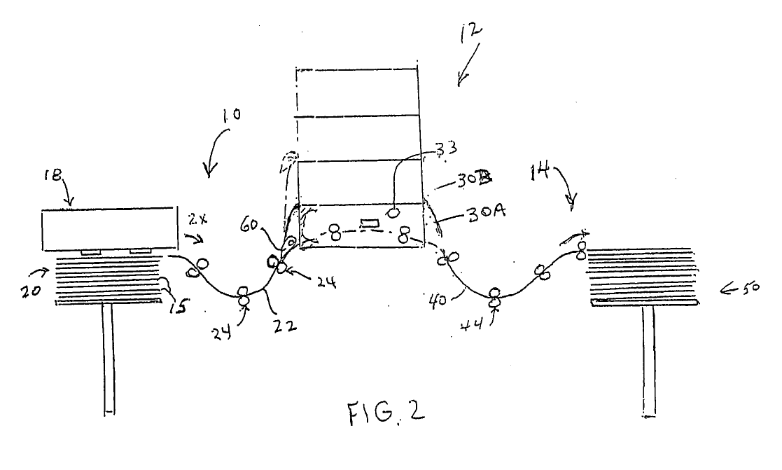

The travel path through the printing heads need not be straight. Instead, the path could be curved as shown in FIG. 2.

The method and apparatus described above could be used for printing identical images on the sheets or different images on the sheets (i.e., variable-data printing).

Another inventive concept, which is independent of the above described invention, but which could be used in conjunction therewith if desired, pertains to variable-data printing, especially variable-data print jobs involving a large set (number) of sheets (pages). As explained earlier, conventional raster image processing (RIP) is typically performed before variable-data printing is initiated, so a considerable time delay may occur before printing begins. Even with the so-called quick-start feature, the time for accomplishing the overall print job is not reduced. This shortcoming of conventional RIP operations minimizes the overall production rate or throughput, adversely affecting profitability.

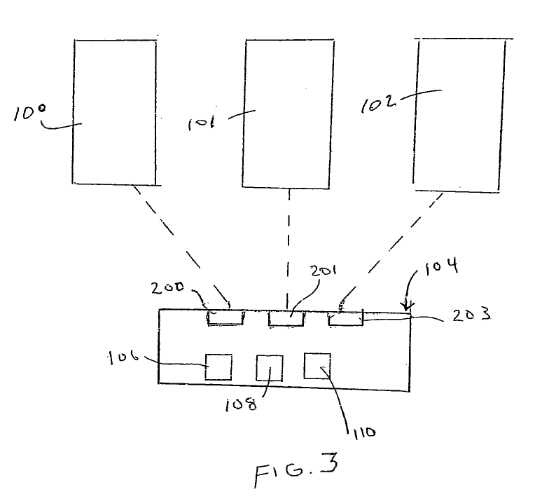

In accordance with the present invention, a plurality of printing units 100, 102, 103, etc., are provided (see FIG. 3). Each printing unit is assigned to print a respective quantity of pages of the page set of a variable printing job. A raster image processing (RIP) system 104 is provided which comprises a plurality of separate computing units 200, 201, 202 connected to respective printers. Each computing unit functions to perform a RIP on a particular quantity of the set of pages. By “quantity” is meant one or more, and by “computing unit” is meant a unit comprised of the necessary components for performing a RIP, such as CPU, memory, mass storage, input and output devices, etc., for example. Although only three printers and three computer units are depicted in FIG. 3, it will be understood that any number more than one could be employed. Thus, no single computing unit performs the RIP of all pages as is done conventionally. Rather, the RIP is divided among a number of computing units which concurrently perform a RIP on respective quantities of the page set.

Each of the computing units could have its own auxiliary components, such as control console, power supply, cooling unit, etc., or the computing units could share a common control console 106, power supply 108 and cooling unit 110 as depicted in FIG. 3.

In operation, if it assumed that a variable data print job is to be carried out involving a set of 90 pages, the computing units 200, 201, 202 could each be assigned a quantity of 30 of those pages and thereby perform a RIP on only those 30 pages. Once each computing unit completes the RIP of its respective 30 pages, it sends a corresponding signal to its respective printer to print those pages. Since the RIP is performed in parallel, and the printing is performed in parallel, the time for the printing job is reduced.

Moreover, since the printing of a page can typically be performed more quickly than the RIP of the same page, it may not be necessary to provide one printer for each computing unit. Rather, two or more computer units could be assigned a common printer.

In accordance with the invention, it is unnecessary to wait for one computer unit to perform the RIP of all pages of a printing job, thus eliminating what has been, in many cases, a considerable delay in completing the printing operation.

What is claimed is:

1. A printing method for printing images on printable blank sheets, comprising the steps of:
A. advancing sheets along an infeed path at a feeding speed to a printing section comprised of at least two printing units;
B. guiding successive sheets alternatingly into the printing units;
C. conveying the sheets past print heads of the respective printing units at a printing speed lower than the first speed, to apply print medium to the sheets;
D. conveying the sheets past fixing devices of the respective printing units which fix the print medium;
E. discharging the sheets; and
F. repeating steps A-E until a desired number of sheets has been printed.

2. The printing method according to claim 1 wherein the feeding speed is defined as approximating the printing speed multiplied by the number of printing units in operation.

3. The printing method according to claim 2, wherein the feeding speed constitutes a first feeding speed, and further comprising the step of discharging the printed sheets from the printing units to an outfeed path and advancing the printed sheets along the outfeed path at a speed approximately equal to the first feeding speed, and depositing the printed sheets onto a common stacker pile.

4. The printing method according to claim 1 wherein the printing units are vertically stacked.

5. The printing method according to claim 1 wherein the printing units are of the inkjet type.

6. A printing apparatus comprising:
an advancing mechanism for advancing the sheets along the infeed path at a feeding speed;
a printing section comprised of at least two printing units, each printing unit including a print head arrangement and a sheet conveying mechanism for advancing the sheets past the print head arrangement at a printing speed slower than the feeding speed to apply print medium thereto, and a fixing device for fixing the print medium; and
a guiding mechanism for guiding successive sheets alternatingly into the printing units.

7. The printing apparatus according to claim 6, wherein the feeding speed is set at approximately the printing speed multiplied by the number of printing units.

8. The printing apparatus according to claim 7, wherein the first feeding speed and the advancing mechanism constitute a first feeding speed and a first advancing mechanism, respectively; and further comprising an outfeed path arranged to receive printed sheets from the printing units, and a second advancing mechanism for advancing the printed sheets along the outfeed path to a stacker pile at a second feeding speed equal to the first feeding speed.

9. The printing apparatus according to claim 7 wherein the guiding mechanism includes a movable gate arranged in the infeed path.

10. The apparatus according to claim 9 wherein the printing units are vertically stacked.

11. The apparatus according to claim 9 wherein the printing units are of the inkjet type.

12. The printing apparatus according to claim 4 wherein the inkjet printing units comprise digital printing units.

13. A method of variable-data printing of a set of pages comprising the steps of:
A) providing a plurality of RIP computing units; and
B) assigning respective quantities of the page set to respective ones of the RIP computing units, wherein each computing unit performs a RIP of its respective page quantity and sends corresponding signals to a printer for printing the page quantity.

14. The method according to claim 13 wherein the computing units send the signals to respective printers.

15. A variable-data printing system, comprising:
a printing apparatus, and
a plurality of RIP computing units connected to the printing apparatus for concurrently performing a RIP operation on respective page quantities of a set of pages to be printed.

16. The apparatus according to claim 15 wherein the printing apparatus comprises a plurality of printers connected to respective computing units.
